(19) United States
(12) Patent Application Publication
(10) Pub. No.: US 2014/0005323 A1
(43) Pub. Date: Jan. 2, 2014

(54) MANUFACTURE OF ETHYLENE/CARBOXYLIC ACID COPOLYMERS FROM RENEWABLE MATERIALS, COPOLYMERS OBTAINED AND USES

(71) Applicant: ARKEMA FRANCE, Colombes (FR)

(72) Inventors: Samuel DEVISME, Rouen (FR); Fabrice R. Chopinez, Bala Cynwyd Circle, PA (US); Christian Laurichesse, Lons (FR); Thomas Roussel, Lyon (FR); Jean-Luc Dubois, Millery (FR)

(73) Assignee: ARKEMA FRANCE, Colombes (FR)

(21) Appl. No.: 14/020,274

(22) Filed: Sep. 6, 2013

Related U.S. Application Data
(62) Division of application No. 13/129,157, filed on Jul. 29, 2011.

(30) Foreign Application Priority Data
Nov. 13, 2008 (FR) 0857689

(51) Int. Cl. C08F 210/02; C08L 23/08

(52) U.S. Cl. CPC C08F 210/02; C08L 23/0869
USPC 524/517; 526/329; 525/187; 525/190; 524/522; 524/523; 435/135

(57) ABSTRACT

A process for the manufacture of copolymers of ethylene and of at least one vinyl ester, comprising the following steps: a) fermentation of renewable starting materials so as to produce at least one alcohol comprising ethanol; b) dehydration of the alcohol obtained so as to produce at least one alkene comprising ethylene and, optionally, purification of the alkene so as to obtain ethylene, c) copolymerization of the ethylene with at least one vinyl ester, d) isolation of the copolymer obtained. Also, copolymers of ethylene and of at least one vinyl ester in which the ethylene is at least partly obtained from renewable starting materials, and to uses thereof.

### CROSS REFERENCE TO RELATED APPLICATIONS

The present application is a divisional of U.S. application Ser. No. 13/129,157, filed on Jul. 29, 2011, which is a national stage application of International Application No. PCT/FR2009/052166, filed on Nov. 10, 2009, which claims the benefit of French Application No. 08-57689, filed on Nov. 13, 2008. The entire contents of each of U.S. application Ser. No. 13/129,157, International Application No. PCT/FR2009/052166, and French Application No. 08-57689 are hereby incorporated herein by reference in their entirety.

### FIELD OF THE INVENTION

The present invention relates to copolymers of ethylene and of at least one unsaturated carboxylic acid or unsaturated carboxylic acid derivative, in which the ethylene is at least partially obtained from renewable starting materials.

### STATE OF THE ART

One of the problems posed by copolymers comprising ethylene of the prior art is that they are produced starting from nonrenewable starting materials of fossil (oil) origin. In point of fact, oil resources are limited and the extraction of oil requires drilling to increasingly deep depths and under technical conditions which are ever more difficult, requiring sophisticated equipment and use of processes which are ever more expensive in energy. These constraints have a direct consequence with regard to the cost of manufacture of ethylene and thus of ethylene-based copolymers.

Advantageously and surprisingly, the inventors of the present patent application have employed a process for the industrial manufacture of ethylene-based copolymers from renewable starting materials.

The process according to the invention makes it possible to dispense, at least in part, with starting materials of fossil origin and to replace them with renewable starting materials.

In addition, the ethylene-based copolymers obtained according to the process according to the invention are of a quality such that they can be used in all the applications in which the use of these copolymers is known, including in applications with the highest standards.

### SUMMARY OF THE INVENTION

A subject matter of the invention is copolymers of ethylene and of at least one unsaturated carboxylic acid or unsaturated carboxylic acid derivative, in which the ethylene is at least partially obtained from renewable starting materials.

In the present patent application, reference is made to compounds (ethylene, unsaturated carboxylic acids) comprising carbon atoms “obtained from renewable starting materials”; thus, within the meaning of the present patent application, it will be understood that these compounds comprise ¹⁴C carbon atoms which can be determined according to the standard ASTM D 6866-06. For example, the copolymer can comprise at least 0.24×10⁻¹⁰% by weight of ¹⁴C.

Within the meaning of the present patent application, the term “copolymers of ethylene and of at least one unsaturated carboxylic acid or unsaturated carboxylic acid derivative” is understood to mean all the copolymers comprising at least these two monomers; in particular, this definition covers terpolymers comprising ethylene and at least one unsaturated carboxylic acid or unsaturated carboxylic acid derivative.

According to a specific alternative form, at least a portion of the carbon atoms of the unsaturated carboxylic acid or of the unsaturated carboxylic acid derivative is of renewable origin.

Preferably, the unsaturated carboxylic acid is acrylic acid or methacrylic acid (hereinafter (meth)acrylic acid).

Preferably, the unsaturated carboxylic acid derivative is an unsaturated carboxylic acid ester, an unsaturated carboxylic acid anhydride or an unsaturated epoxide.

Advantageously, the unsaturated carboxylic acid esters are alkyl (meth)acrylates, the number of carbon atoms of the alkyl part of the alkyl (meth)acrylates preferably ranging from 1 to 24; in particular, the alkyl (meth)acrylates are chosen from methyl acrylate, ethyl acrylate, n-butyl acrylate, isobutyl acrylate or 2-ethylhexyl acrylate. Particularly preferably, use is made of methyl acrylate, n-butyl acrylate and 2-ethylhexyl acrylate.

Advantageously, the unsaturated carboxylic acid anhydrides are chosen from maleic anhydride, itaconic anhydride, citraconic anhydride or tetrahydrophthalic anhydride; in particular, maleic anhydride is used.

The unsaturated epoxides are chosen in particular from:
aliphatic glycidyl esters and ethers, such as allyl glycidyl ether, vinyl glycidyl ether, glycidyl maleate, glycidyl itaconate, glycidyl acrylate and glycidyl methacrylate (GMA), and
alicyclic glycidyl esters and ethers, such as 2-cyclohexen-1-yl glycidyl ether, diglycidyl cyclohexene-4,5-dicarboxylate, glycidyl cyclohexene-4-carboxylate, glycidyl 5-norbornene-2-methyl-2-carboxylate and diglycidyl endo-cis-bicyclo[2.2.1]hept-5-ene-2,3-dicarboxylate.

The present patent application also relates to the blends of copolymers according to the invention, to the compositions comprising these copolymers and to the uses of these copolymers.

The copolymers of ethylene and of at least one unsaturated carboxylic acid or unsaturated carboxylic acid derivative according to the present patent application are capable of being obtained according to the manufacturing process comprising the following stages:
a) fermentation of renewable starting materials and optionally purification, in order to produce at least one alcohol chosen from ethanol and mixtures of alcohols comprising ethanol;
b) dehydration of the alcohol obtained in order to produce at least one alkene chosen from ethylene and mixtures of alkenes comprising ethylene and optionally purification of the alkene in order to obtain ethylene,
c) copolymerization of the ethylene with at least one comonomer chosen from unsaturated carboxylic acid or unsaturated carboxylic acid derivative,
d) isolation of the copolymer obtained.

Other subject matters, aspects or characteristics of the invention will become apparent on reading the following description.

### DESCRIPTION OF THE DRAWINGS

FIG. 1: shows a device which makes possible the implementation of the copolymerization process according to the invention according to a technique in which the reactants are injected at several points.

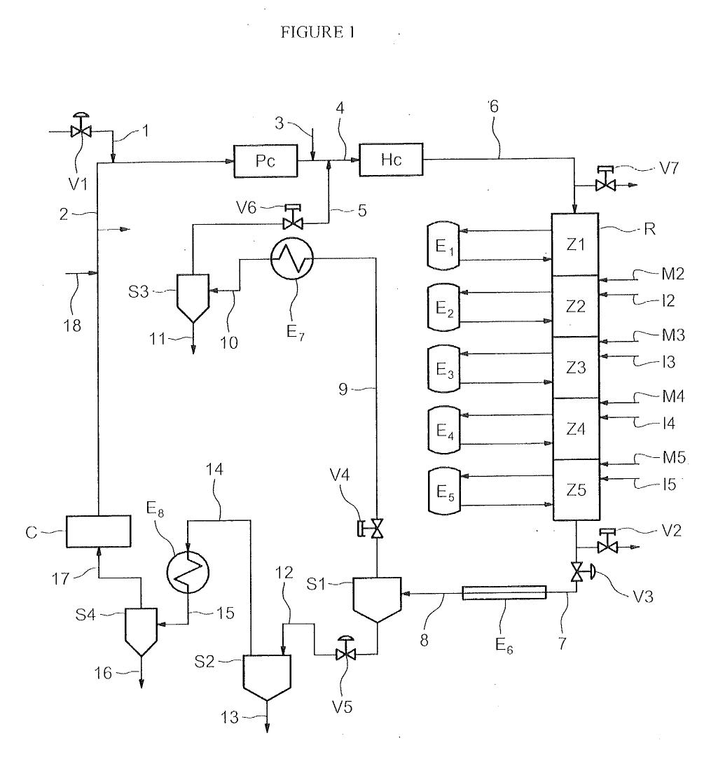

### DETAILED DESCRIPTION OF THE INVENTION

Stage a) of the process for the manufacture of copolymers of ethylene and of at least one unsaturated carboxylic acid or unsaturated carboxylic acid derivative according to the invention comprises the fermentation of renewable starting materials in order to produce at least one alcohol, said alcohol being chosen from ethanol and mixtures of alcohols comprising ethanol.

A renewable starting material is a natural resource, for example animal or plant, the stock of which can be built up again over a short period on the human scale. In particular, it is necessary for this stock to be able to be renewed as quickly as it is consumed. For example, plant materials exhibit the advantage of being able to be cultivated without their consumption resulting in an apparent reduction in natural resources.

Unlike the materials resulting from fossil materials, renewable starting materials comprise ¹⁴C. All the samples of carbon drawn from living organisms (animal or plant) are in fact a mixture of 3 isotopes: ¹²C (representing approximately 98.892%), ¹³C (approximately 1.108%) and ¹⁴C (traces: 1.2×10⁻¹⁰%). The ¹⁴C/¹²C ratio of living tissues is identical to that of the atmosphere. In the environment, ¹⁴C exists in two predominant forms: in the form of carbon dioxide gas (CO₂) and in organic form, that is to say in the form of carbon incorporated in organic molecules.

In a living organism, the ¹⁴C/¹²C ratio is kept constant by the metabolism because the carbon is continually exchanged with the external environment. As the proportion of ¹⁴C in the atmosphere is constant, it is the same in the organism as long as it is alive, since it absorbs this ¹⁴C in the same way as the ambient ¹²C. The mean ¹⁴C/¹²C ratio is equal to 1.2×10⁻¹².

¹²C is stable, that is to say that the number of ¹²C atoms in a given sample is constant over time. ¹⁴C is radioactive; the number of ¹⁴C atoms in a sample decreases over time (t), its half-life being equal to 5730 years.

The ¹⁴C content is substantially constant from the extraction of the renewable starting materials up to the manufacture of the copolymer according to the invention and even up to the end of the lifetime of the object manufactured in said copolymer.

Consequently, the presence of ¹⁴C in a material, whatever the amount thereof, gives an indication with regard to the origin of the molecules constituting it, namely whether they originate from renewable starting materials and not from fossil materials.

The amount of ¹⁴C in a material can be determined by one of the methods described in the standard ASTM D 6866-06 (Standard Test Methods for Determining the Biobased Content of Natural Range Materials Using Radiocarbon and Isotope Ratio Mass Spectrometry Analysis).

This standard comprises three methods of measuring the organic carbon resulting from renewable starting materials, referred to as “biobased carbon”. The proportions indicated for the copolymer of the invention are preferably measured according to the mass spectrometry method or the liquid scintillation spectrometry method described in this standard and very preferably by mass spectrometry.

These measurement methods evaluate the ratio of the ¹⁴C/¹²C isotopes in the sample and compare it with a ratio of the ¹⁴C/¹²C isotopes in a material of biological origin giving the 100% standard, in order to measure the percentage of organic carbon in the sample.

Preferably, the copolymer according to the invention comprises an amount of carbon resulting from renewable starting materials of greater than 20% by weight, preferably of greater than 50% by weight, with respect to the total weight of carbon of the copolymer.

In other words, the copolymer can comprise at least 0.24×10⁻¹⁰% by weight of ¹⁴C and preferably at least 0.6×10⁻¹⁰% by weight of ¹⁴C.

Advantageously, the amount of carbon resulting from renewable starting materials is greater than 75% by weight, preferably equal to 100% by weight, with respect to the total weight of carbon in the copolymer.

Use may be made, as renewable starting materials, of plant materials, materials of animal origin or materials of plant or animal origin resulting from recovered materials (recycled materials).

Within the meaning of the invention, the materials of plant origin comprise at least sugars and/or starches.

The plant materials comprising sugars are essentially sugar cane and sugar beet; mention may also be made of maple, date palm, sugar palm, sorghum or American agave; the plant materials comprising starches are essentially cereals and legumes, such as corn, wheat, barley, sorghum, rice, potato, cassaya or sweet potato, or algae.

Mention may in particular be made, among materials resulting from recovered materials, of plant or organic waste comprising sugars and/or starches.

Preferably, the renewable starting materials are plant materials.

The fermentation of the renewable materials takes place in the presence of one or more appropriate microorganisms; this microorganism may optionally have been modified naturally, by a chemical or physical stress, or genetically; the term used is then mutant. Conventionally, the microorganism used is Saccharomyces cerevisiae or one of its mutants.

Use may also be made, as renewable starting materials, of materials comprising cellulose or hemicellulose, indeed even lignin, which can be converted to sugar-comprising materials in the presence of the appropriate microorganisms. These renewable materials include straw, wood or paper. These materials can advantageously originate from recovered materials.

The lists presented above are not limiting.

Preferably, the fermentation stage is followed by a purification stage intended to separate the ethanol from the other alcohols.

The alcohol or alcohols obtained are dehydrated in stage b) in order to produce, in a first reactor, at least one alkene chosen from ethylene and mixtures of alkenes comprising ethylene, the byproduct from the dehydration being water.

Generally, the dehydration of the alcohol is carried out using a catalyst based on α-alumina, such as the catalyst sold by Eurosupport under the trade name ESM 110® (undoped trilobe alumina not comprising much residual Na₂O (approximately 0.04%)).

The operating conditions for the dehydration form part of the general knowledge of a person skilled in the art; by way of indication, the dehydration is generally carried out at a temperature of the order of 400° C.

Another advantage of the process according to the invention is its saving in energy: the fermentation and dehydration stages of the process according to the invention are carried out at relatively low temperatures of less than 500° C., preferably of less than 400° C.; in comparison, the stage of cracking and steam cracking oil to give ethylene is carried out at a temperature of the order of 800° C.

This saving in energy is also accompanied by a decrease in the level of CO₂ emitted to the atmosphere.

Preferably, a purification stage is carried out during stage a) or during stage b).

The optional stages of purification (purification of the alcohol(s) obtained in stage a), purification of the alkene(s) obtained in stage b)) are advantageously carried out by absorption on conventional filters, such as molecular sieves, zeolites, carbon black, and the like.

If the alcohol obtained in stage a) was purified so as to isolate the ethanol, the alkene obtained in stage b) is ethylene.

If the alcohol obtained in stage a) was not purified, a mixture of alkenes comprising ethylene is obtained on conclusion of stage b).

Advantageously, at least one purification stage is carried out during stage a) and/or stage b) in order to obtain ethylene with a degree of purity sufficient to carry out a copolymerization.

Particularly preferably, the alcohol obtained in stage a) is purified so as to isolate the ethanol; consequently, the alkene obtained in stage b) is ethylene.

The main impurities present in the ethylene resulting from the dehydration of the ethanol are ethanol, propane and acetaldehyde.

Advantageously, the ethylene should be purified, that is to say that the ethanol, the propane and the acetaldehyde should be removed, in order to be able to easily copolymerize in stage c).

The ethylene, the ethanol, the propane and the acetaldehyde can be separated by carrying out one or more low-temperature distillations.

The boiling points of these compounds are as follows:

| Compound | Boiling point (° C.) |
|---|---|
| Ethylene | −103.7 |
| Propane | −42.1 |
| Acetaldehyde | 20.8 |
| Ethanol | 75.5 |

The ethylene, the ethanol, the propane and the acetaldehyde are cooled to approximately −105° C., preferably −103.7° C., and then distilled in order to extract the ethylene.

Another advantage of the process according to the present invention relates to the impurities. The impurities present in the ethylene resulting from the dehydration of the ethanol are completely different from those present in the ethylene resulting from steam cracking. In particular, the impurities present in the ethylene resulting from steam cracking include dihydrogen and methane, this being the case whatever the composition of the initial feedstock. Conventionally, dihydrogen and methane are separated after compressing to 36 bar and cooling to approximately −120° C. Under these conditions, the dihydrogen and the methane, which are liquids, are separated in the demethanizer and then the ethylene is recovered at 19 bar and −33° C.

The process according to the present patent application makes it possible to dispense with the stage of separation of the dihydrogen and methane and also makes it possible to cool the mixture to −105° C. at atmospheric pressure instead of −120° C. at 36 bar. The cooling of this separation stage can also take place under pressure in order to increase the boiling point of the compounds to be separated (for example approximately 20 bar and −35° C.).

These differences also contribute to rendering the process according to the invention more economic (saving in equipment and saving in energy, which are also accompanied by a reduction in the level of CO₂ emitted to the atmosphere).

Another advantage is that the ethylene obtained in stage b) of the process according to the invention does not comprise acetylene, in contrast to the ethylene obtained by cracking or steam cracking. In point of fact, acetylene is highly reactive and brings about oligomerization side reactions; it is therefore particularly advantageous to obtain acetylene-free ethylene.

Another advantage is that the process according to the invention can be carried out in production units located on the site of production of the starting materials. In addition, the size of the production units of the process according to the invention is much smaller than the size of a refinery: specifically, refineries are large installations which are generally situated far from the centers of production of the starting materials and which are supplied via pipelines.

In stage c), the ethylene is copolymerized with at least one unsaturated carboxylic acid or unsaturated carboxylic acid derivative, generally by a high-pressure radical copolymerization. The polymerization in stage c) can be carried out in an autoclave or tubular reactor; preferably, this process is carried out in a tubular reactor.

In particular, in stage c), the ethylene is copolymerized with at least one unsaturated carboxylic acid and/or unsaturated carboxylic acid derivative, generally by a high-pressure radical copolymerization.

The high-pressure radical copolymerization is generally carried out by introducing the ethylene, the comonomer or comonomers (the comonomers comprise at least one unsaturated carboxylic acid and/or one unsaturated carboxylic acid derivative) and an initiator of polymerization at elevated pressure into an autoclave or tubular reactor at a temperature of between 80 and 325° C. in the tubular reactor and between 150 and 290° C. in the autoclave reactor. The amount of the comonomers introduced can range up to 20% by weight, with respect to the total amount of ethylene and comonomers introduced into the reactor, which makes it possible to obtain a copolymer comprising up to 50% by weight of comonomers.

The pressure is regulated using a pressure-reducing valve situated at the outlet of the reactor. The polymer formed is recovered at the outlet of the reactor and the unreacted monomer is preferably recycled at the beginning of the reactor. The pressure inside the reactor is advantageously between 500 and 3000 bar and preferably between 1000 and 2500 bar.

Use may be made, with the comonomers and initiator, of a transfer agent; this transfer agent can, for example, be one or more alkanes, such as butane or pentane, one or more alkenes, such as propylene or butene, one or more aldehydes, such as propionaldehyde or acetaldehyde, or one or more ketones, such as acetone or methyl ethyl ketone. The molar mass of the polymer manufactured can be limited by adding this transfer agent.

Use may be made, as polymerization initiator, of any organic or inorganic compound which releases free radicals under the conditions of the reaction; preferably, use will be made of compounds or mixtures of compounds comprising a peroxide group, for example of the following compounds: tert-butyl peroxyneodecanoate, tert-butyl peroxypivalate, tert-amyl peroxypivalate, di(3,5,5-trimethylhexanoyl) peroxide, didecanoyl peroxide, tert-amyl peroxy-2-ethylhexanoate, tert-butyl peroxy-2-ethylhexanoate, tert-butyl peroxy-3,5,5-trimethylhexanoate, tert-amyl peroxy-3,5,5-trimethylhexanoate, tert-butyl peroxybenzoate, tert-butyl peroxyacetate or di(tert-amyl) peroxide.

Generally, the amount by weight of polymerization initiator is between 1 and 1000 ppm.

When a tubular reactor is used, the introduction of the mixture of ethylene and comonomers is preferably carried out at the top of the tubular reactor. The initiator or the mixture of initiators is injected, using a high-pressure pump, at the top of the reactor, after the point of introduction of the mixture of ethylene and comonomers.

The mixture of ethylene and comonomers can be injected at least at another location in the reactor; this injection is itself followed by a further injection of initiator or of a mixture of initiators; the term used is then multipoint injection technique. When the multipoint injection technique is used, the mixture is preferably injected in a way such that the ratio by weight of the mixture injected at the reactor inlet to the whole of the mixture injected is between 10 and 90%.

Examples of processes which can be used to prepare a copolymer of ethylene with an unsaturated acrylic acid ester are, for example, those described in U.S. Pat. No. 4,788,265, US2006/0149004 A1 or US2007/0032614 A1

Use may also be made of an autoclave reactor for carrying out the high-pressure radical polymerization.

An autoclave reactor generally consists of a cylindrical reactor in which a stirrer is placed. Advantageously, the residence time in the reactor is between 30 and 120 seconds. Preferably, the length/diameter ratio of the reactor is between 3 and 25. The reactor can be separated into several zones connected to one another in series. The ethylene alone and the comonomer or comonomers are injected into the first zone of the reactor at a temperature of between 20 and 120° C., preferably between 50 and 80° C. An initiator is also injected into this first reaction zone. If the reactor is a multizone reactor, the stream of unreacted ethylene and comonomers and the polymer formed then pass into the following reaction zones. Ethylene, comonomers and initiators can be injected in each zone. The temperature of the zones is between 150° C. and 290° C. and preferably between 160° C. and 280° C. The pressure of the reactor is between 500 and 3000 bar and preferably between 1200 and 2200 bar.

Other copolymerization processes which can be used are, for example, those described in the patent applications FR 2 660 660, FR 2 498 609, FR 2 569 411 and FR 2 569 412.

A device which makes possible the implementation of the copolymerization process according to the invention according to a technique in which the reactants are injected at several points is presented in the single FIGURE appended as an annex.

This device comprises a tubular reactor R comprising five zones Z1, Z2, Z3, Z4 and Z5, a medium-pressure separator S1, which forms the inlet into a medium-pressure recycling circuit, and a low-pressure separator S2, which forms the inlet into a low-pressure recycling circuit.

The medium-pressure recycling circuit comprises the medium-pressure separator S1, the pipe 9 provided with the valve V4, the heat exchanger E7, the pipe 10, the separator S3 and the pipe 5 provided with the valve V6.

The low-pressure recycling circuit comprises the low-pressure separator S2, the pipe 14, the heat exchanger E8, the pipe 15, the separator S4, the pipe 17, the compressor C and the pipe 2.

The tubular reactor R is a tube comprising a jacket in which circulates water intended to contribute or remove heat for the purpose of heating or cooling the fluid moving through the reactor. The tubular reactor R comprises five zones Z1, Z2, Z3, Z4 and Z5 to which five parts of the jacket correspond: E1 is the part of the jacket situated around the zone Z1, E2 is the part of the jacket situated around the zone Z2, E3 is the part of the jacket situated around the zone Z3, E4 is the part of the jacket situated around the zone Z4 and E5 is the part of the jacket situated around the zone Z5; the temperature of the water circulating in each of the parts E1, E2, E3, E4 and E5 can be different.

According to this device, fresh ethylene moving through the pipe 1 (at a pressure of 60 bar) is admitted into the pipe 2 of the device. The pipe 1 is provided with a pressure-reducing valve V1.

In the pipe 2, this fresh ethylene is mixed with a gas stream (recycling of the ethylene and of the comonomer or comonomers of the low-pressure recycling circuit) originating from the compressor C.

The pipe 2 feeds the mixture to a precompressor Pc (where the mixture is compressed from 60 bar to 200 bar) and then the mixture exits from the precompressor Pc via the pipe 4. Fresh comonomers are introduced into the pipe 4 by means of the pipe 3. Downstream of the pipe 3, the pipe 5 introduces, into the pipe 4, the mixture of recycled fluids originating from the medium-pressure recycling circuit.

The mixture moving through the pipe 4 is introduced into the hypercompressor Hc (where the mixture is compressed from 200 bar to a pressure of between 1200 and 2500 bar, which is the pressure in the reactor) and then the mixture exits from the hypercompressor Pc via the pipe 6.

The pressure inside the reactor is regulated by the pressure-reducing valve V2.

If need be, the valve V7 makes it possible to regulate the pressure of the mixture in the pipe 6.

The reactor used comprises 5 zones: the mixture comprising the ethylene and the comonomer or comonomers and optionally a transfer agent is admitted into the zone Z1 of the reactor (at the reactor inlet) by means of the pipe 6.

In the zone Z1, the mixture is heated up to the temperature of initiation of the polymerization reaction (between 90 and 170° C.).

At the inlet of the zone Z2, a mixture of ethylene and of comonomers can be introduced by means of the pipe M2 and a polymerization initiator (generally at least one peroxide and/or molecular oxygen) can be introduced by means of the pipe 12.

Then, in the zones Z3, Z4 and Z5, the pipes M3, M4 and M5 respectively make it possible to carry out additions of mixtures of ethylene and comonomers and the pipes 13, 14 and 15 respectively make it possible to carry out additions of polymerization initiator.

The polymerization reaction is highly exothermic and the temperature of the mixture which passes through the tubular reactor gradually increases.

A portion of the heat generated by the copolymerization reaction in the zones Z1, Z2, Z3, Z4 and Z5 is recovered by the water circulating in the corresponding part of the jacket E1, E2, E3, E4 and E5 respectively.

When additions by means of the pipes M2 to M5 and 12 to 15 are carried out in each zone Z1, Z2, Z3, Z4 and Z5, an identical temperature profile is obtained with a rise in the temperature up to a peak of between 180° C. and 325° C. (the beginning of the rise in temperature being due to the injection of the polymerization initiator and of the mixture) and then a decrease in the temperature (which corresponds to the end of the polymerization reaction and to the cooling of the stream by the jacket).

Before departing from the reactor, the mixture comprising the polymer is cooled to a temperature of between 140° C. and 240° C.

The mixture comprising the polymer exits from the reactor via the pipe 7 provided with a valve V3 which makes it possible to reduce the mixture in pressure, to a pressure of approximately 260 bar. The mixture then enters the heat exchanger E6, where it is cooled and departs therefrom via the pipe 8.

The pipe 8 conveys the mixture to the medium-pressure separator S1. In S1, the copolymer formed is separated from the mixture of the unreacted products: ethylene, comonomers and transfer agent.

The mixture of the unreacted products is conveyed to the heat exchanger E7 via the pipe 9, where it is cooled and then exits from the heat exchanger E7 via the pipe 10. The pipe 10 conveys the products to the separator S3, where the polymer waxes (having a low weight and which were not separated in the separator S1) are isolated and extracted from the device via the pipe 11. The pipe 5, provided with a valve V6, conveys the mixture of ethylene, comonomers and transfer agent from the separator S3 to the pipe 4.

The copolymer exits from the separator S1 via the pipe 12 provided with a valve V5 and is introduced into the low-pressure separator S2. The valve V5 makes it possible to reduce the copolymer in pressure to a pressure of approximately 2 to 5 bar. The copolymer is extracted from the device via the pipe 13 and then it is sent to an extruder in order to be converted into granules.

The pipe 14 makes it possible to discharge the gas mixture (ethylene/comonomers, transfer agent which were not separated in the separator S1); this mixture is conveyed to the heat exchanger E8 via the pipe 14, where it is cooled down to approximately 35° C. and then exits from the heat exchanger E8 via the pipe 15. The pipe 15 conveys the products to the separator S4, where the monomers are condensed. A portion of the monomers is extracted from the device via the pipe 16 and the other portion of the monomers is introduced via the pipe 17 into the compressor C (where they are compressed at 60 bar).

The monomers exit from the compressor via the pipe 2. The pipe 18 makes it possible to introduce the transfer agents into the pipe 2.

In stage d), the copolymer obtained is isolated and optionally purified, according to a conventional technique, as a function of the application for which it is intended.

According to a specific alternative form, when the copolymer according to the invention comprises maleic anhydride, use may be made of maleic anhydride comprising carbon atoms of renewable origin.

The maleic anhydride can be obtained according to the process described in the application FR 0 854 896 of the applicant company, comprising the following stages:
a) fermentation of renewable starting materials and optionally purification in order to produce a mixture comprising at least butanol;
b) oxidation of the butanol to give maleic anhydride at a temperature generally of between 300 and 600° C., using a catalyst based on vanadium and/or molybdenum oxide;
c) isolation of the maleic anhydride obtained on conclusion of stage b).

According to another specific alternative form, when the copolymer according to the invention comprises acrylic acid, use may be made of acrylic acid comprising carbon atoms of renewable origin.

For example, the acrylic acid can be obtained according to the process described in the application FR 2 884 817 of Arkema S. A. by dehydration of glycerol in the presence of molecular oxygen.

According to another specific alternative form, when the copolymer according to the invention comprises methyl methacrylate, use may be made of methyl methacrylate comprising carbon atoms of renewable origin.

For example, the methyl methacrylate can be obtained according to the teaching of the application FR 0 853 588 of Arkema France.

This application describes essentially two processes for the manufacture of methyl methacrylate:
a first process comprising the following stages:
   in a first stage, hydrocyanic acid is condensed with acetone via basic catalysis in order to obtain acetone cyanohydrin;
   in a second stage, the acetone cyanohydrin is reacted in a concentrated sulfuric acid medium in order to obtain α-hydroxyisobutyramide monosulfate, which is converted to methacrylamide sulfate under the action of the heat of the reaction, which is highly exothermic;
   in a third stage, the methacrylamide is hydrolyzed and esterified with methanol, in order to form methyl methacrylate and ammonium hydrogen sulfate, and the desired methyl methacrylate is recovered;
a second process comprising the following stages:
   in a first stage, hydrocyanic acid is condensed with acetone via basic catalysis in order to obtain acetone cyanohydrin;
   in a second stage, the acetone cyanohydrin is reacted with methanol in order to obtain methyl hydroxymethacrylate;
   in a third stage, the methyl hydroxymethacrylate is dehydrated in order to recover the desired methyl methacrylate.

The acetone, the hydrocyanic acid and/or the methanol used in these processes can be obtained from renewable materials.

The acetone can be obtained according to one of the three following processes:
1. acetone-butanol fermentation of C₆ and C₅ sugars, resulting in an acetone-butanol mixture optionally comprising ethanol, and separation of the acetone, for example by distillation, in particular azeotrope distillation, or by membrane separation or separation over silica lite;
2. hydrothermal liquefaction at 573K of sewage sludge, in order to obtain a black liquor comprising hydrocarbons, then catalytic cracking of said black liquor in a steam atmosphere over a catalyst based on zirconia or zirconia/alumina supported on an iron oxide and subsequent separation of the acetone, for example by distillation, in particular azeotrope distillation, or by membrane separation or separation over silicalite;
3. catalytic conversion of palm oil waste over a catalyst formed of zirconia or zirconia/alumina supported on an iron oxide and subsequent separation of the acetone, for example by distillation, in particular azeotrope distillation, or by membrane separation or separation over silicalite.

The hydrocyanic acid can be obtained according to one of the following processes:
ammoxidation of methane, the methane having been obtained by fermentation, in the absence of oxygen, of animal and/or plant organic matter, such as pig manure, household waste or industrial waste, resulting in a biogas essentially composed of methane and carbon dioxide gas, the carbon dioxide gas having been removed by washing with biogas using a basic aqueous solution of sodium hydroxide, potassium hydroxide or amine, or also with water under pressure, or by absorption in a solvent, such as methanol;
ammoxidation of methanol, the methanol having been obtained by pyrolysis of wood or by gasification of any material of animal or plant origin, resulting in a syngas composed essentially of carbon monoxide and hydrogen which is reacted with water, or by fermentation starting from plant crops, such as wheat, sugarcane or beet, giving fermentable products and thus alcohol.

The methanol can be obtained by pyrolysis of wood or by gasification of any material of animal or plant origin, resulting in a syngas composed essentially of carbon monoxide and hydrogen which is reacted with water, or by fermentation starting from plant crops, such as wheat, sugarcane or beet, giving fermentable products and thus alcohol.

Preferably, the copolymers according to the invention are chosen from:
random copolymers of ethylene and of methacrylic acid, random copolymers of ethylene and of acrylic acid, random copolymers of ethylene and of methyl acrylate, random copolymers of ethylene and of butyl acrylate, copolymers of ethylene and of 2-ethylhexyl acrylate, random copolymers of ethylene and of maleic anhydride or random copolymers of ethylene and of glycidyl methacrylate,
random terpolymers of ethylene, of butyl acrylate and of maleic anhydride, random terpolymers of ethylene, of methyl acrylate and of maleic anhydride and random terpolymers of ethylene, of methyl acrylate and of glycidyl methacrylate.

The invention also relates to a composition comprising at least one copolymer according to the invention, said composition comprising:
a terpolymer of ethylene, of an unsaturated carboxylic acid ester and of a monomer chosen from unsaturated carboxylic acids, unsaturated carboxylic acid anhydrides and unsaturated epoxides, or
a mixture of a copolymer of ethylene and of an unsaturated carboxylic acid ester and of a copolymer of ethylene and of at least one monomer chosen from unsaturated carboxylic acids, unsaturated carboxylic acid anhydrides and unsaturated epoxides.

The copolymers according to the invention are preferably obtained from 40 to 99% of ethylene by weight and from 1 to 60% of unsaturated carboxylic acid or its derivatives; more preferably, from 55 to 90% of ethylene by weight and from 10 to 45% of unsaturated carboxylic acid and its derivatives.

The terpolymers according to the invention are preferably obtained from 40 to 99.99% of ethylene by weight, from 0 to 45% of unsaturated carboxylic acid or its derivatives by weight and from 0.01 to 15% of maleic anhydride or glycidyl methacrylate; more preferably, from 55 to 94.9% of ethylene by weight, from 5 to 35% of unsaturated carboxylic acid or its derivatives by weight and from 0.1 to 10% of maleic anhydride or glycidyl methacrylate.

The melt flow index MFI of these copolymers is advantageously within the range extending from 0.1 to 1000 g/10 min (ASTM D 1238, 190° C., 2.16 kg), preferably from 1 to 500 g/10 min.

The copolymer or the terpolymer can be amorphous or semicrystalline. When it is semicrystalline, the melting point of the polymer can be between 45° C. and 115° C.

The present invention is also targeted at the copolymers according to the invention grafted by polyamide blocks or by polyether blocks having at least one amine end functional group. These polymers are composed of a backbone (trunk), which is a copolymer or terpolymer of ethylene and at least one unsaturated carboxylic acid or unsaturated carboxylic acid derivative according to the invention, and of at least one graft, which is a polyamide or a polyether block having at least one amine end functional group, the graft(s) being attached to the backbone via the residues of the unsaturated monomers. This is because the residues of the unsaturated monomers are capable of reacting with polyamides/ethers exhibiting an amine end.

The copolymers according to the invention grafted by polyamides correspond to those described in the application FR 2 912 150.

When the graft is of polyamide type, the backbone is preferably composed of a copolymer chosen from random copolymers of ethylene and of maleic anhydride and random terpolymers of ethylene, of alkyl (meth)acrylate and of maleic anhydride.

When the graft is of polyamide type, it can relate to homopolyamides, such as, for example, polyamide 6 monoNH₂, polyamide 11 monoNH₂, polyamide 12 monoNH₂ or polyamide 6,6 monoNH₂, or to copolyamides, such as, for example, copolyamide 6/11 monoNH₂ or copolyamide 6/12 monoNH₂; preferably, these are polyamide 6 monoNH₂, polyamide 11 monoNH₂ or copolyamide 6/11 monoNH₂.

Preferably, they have a molar mass of between 1000 and 5000 g/mol and preferably between 2000 and 4000 g/mol.

The polyamide can comprise, at least in part, carbon atoms of renewable origin, in particular polyamide 11 or 6/11 obtained, at least in part, from castor oil.

The copolymer grafted by a polyamide according to the invention is advantageously a copolymer of ethylene, of alkyl (meth)acrylate and of maleic anhydride with polyamide monoNH₂ grafts.

The copolymers according to the invention grafted with polyamide grafts can advantageously be used as encapsulant in solar panels, as constituent in elastomeric compositions, or to manufacture components exhibiting properties of thermal resistance to oil and to hydrolysis which allow them to be used under an engine hood, for example in the motor vehicle industry.

The copolymers of the invention grafted by polyether blocks having at least one amine end functional group correspond to those described in the application FR 2 897 356.

The backbone is composed of a copolymer chosen from copolymers of ethylene and of alkyl (meth)acrylate, copolymers of ethylene and of carboxylic acid anhydride, such as maleic anhydride, and copolymers of ethylene and of an unsaturated epoxide of the aliphatic glycidyl ester type, such as, in particular, glycidyl methacrylate (GMA).

According to a preferred embodiment, the functionalized polyolefin is a copolymer of ethylene, of ethyl acrylate or of n-butyl acrylate, the content of which is between 2 and 40% by weight of the copolymer, and of maleic anhydride, the content of which is between 0.2 and 6% by weight of the copolymer.

The graft of polyether type having an amine end is typically a polyoxyalkylene glycol having at least one chain end of amine type.

Preferably, the polyoxyalkylene glycol is chosen from polyoxyethylene glycol (PEG), polyoxypropylene glycol (PPG), polyoxytetramethylene glycol (PTMG) or copolymers or blends of these.

An advantageous application of these polymers is their use in the form of “waterproof-breathable” films. These films are of use as roof-decking films or for the cladding of constructions.

Another subject matter of the invention is compositions comprising the copolymer or the terpolymer according to the invention. These compositions can thus comprise, in addition to the copolymer or the terpolymer, at least one additive for improving the properties of the final material and/or at least one other polymer.

These additives include antioxidants; UV protecting agents; “processing” aids having the role of improving the appearance of the final polymer during the processing thereof, such as fatty amides, stearic acid and its salts, ethylenebisstearamide or fluoropolymers; defogging agents; antiblocking agents, such as silica or talc; fillers, such as calcium carbonate and nanofillers, such as, for example, clays; coupling agents, such as silanes; crosslinking agents, such as peroxides; antistatic agents; nucleating agents, pigments; or dyes. These additives are generally used in contents of between 10 ppm and 100 000 ppm by weight, with respect to the weight of the final copolymer. The compositions can also comprise additives chosen from plasticizers, viscosity reducers or flame-retardant additives, such as aluminum or magnesium hydroxides (the latter additives can reach amounts far above 100 000 ppm). Some of these additives can be introduced into the composition in the form of masterbatches.

These compositions can also comprise other polymers, such as polyolefins other than the copolymers according to the invention, polyamide or polyester.

Mention may be made, as examples of polyolefins other than the polymer according to the invention, of homopolymers and copolymers of ethylene, such as very low density polyethylene (VLDPE), low density polyethylene (LDPE), linear low density polyethylene (LLDPE), medium density polyethylene (MDPE), high density polyethylene (HDPE), copolymers comprising ethylene and vinyl acetate or copolymers comprising ethylene and alkyl (meth)acrylate, the ethylene of which does not result from renewable starting materials.

The present application is also targeted at the compositions formed of copolymers according to the invention and more particularly the compositions comprising one or more copolymers of the invention, this (these) copolymer(s) being:
either a terpolymer of ethylene, of an unsaturated carboxylic acid ester and of a comonomer chosen from unsaturated carboxylic acids, unsaturated carboxylic acid anhydrides and unsaturated epoxides,
or a blend of a copolymer of ethylene and of an unsaturated carboxylic acid ester and of a copolymer of ethylene and of at least one comonomer chosen from unsaturated carboxylic acids, unsaturated carboxylic acid anhydrides and unsaturated epoxides, these copolymers comprising ethylene at least in part obtained from material of renewable origin, the comonomers being optionally at least in part obtained from materials of renewable origin.

According to a first alternative form, the composition according to the invention comprises:
from 5 to 100% by weight of a terpolymer of ethylene, of an unsaturated carboxylic acid ester and of a monomer chosen from unsaturated carboxylic acids, unsaturated carboxylic acid anhydrides and unsaturated epoxides,
optionally another copolymer of ethylene, or polyethylene with a density of between 0.86 and 0.96, for example LLDPE (linear low density polyethylene), VLDPE (very low density polyethylene) or LDPE (low density polyethylene).

According to a second alternative form, the composition according to the invention comprises:
from 5 to 95% by weight of a copolymer of ethylene and of an unsaturated carboxylic acid ester,
from 5 to 95% by weight of a copolymer of ethylene and of at least one monomer chosen from unsaturated carboxylic acids, unsaturated carboxylic acid anhydrides and unsaturated epoxides,
optionally another copolymer of ethylene, or polyethylene with a density of between 0.86 and 0.96, for example LLDPE, VLDPE or LDPE.

Another subject matter of the present application is the compositions according to the first alternative form or according to the second alternative form described above in which the amount of comonomer chosen from unsaturated carboxylic acids, unsaturated carboxylic acid anhydrides and unsaturated epoxides included in the copolymer or in the terpolymer is less than 1% by weight, with respect to the total weight of the composition.

The copolymers according to the invention can be used in an extrusion-coating process for application to a support or in an extrusion-lamination process for adhesively bonding several supports together, which supports may or may not be different in nature, within a broad temperature range.

The present application is also targeted at the uses of the copolymers according to the invention and compositions comprising at least one copolymer according to the invention.

The present application is targeted in particular at the uses of the copolymers and compositions according to the invention as adhesive or adhesive composition, in particular in coextrusion, in extrusion-coating or in extrusion-lamination.

A preferred composition of copolymers according to the invention is
according to a first alternative form:
   from 5 to 100% by weight of a terpolymer of ethylene, of an unsaturated carboxylic acid ester and of a monomer chosen from unsaturated carboxylic acids, unsaturated carboxylic acid anhydrides and unsaturated epoxides,
   optionally another copolymer of ethylene, or polyethylene with a density of between 0.86 and 0.96, for example LLDPE (linear low density polyethylene), VLDPE (very low density polyethylene) or LDPE (low density polyethylene);
according to a second alternative form,
   from 5 to 95% by weight of a copolymer of ethylene and of an unsaturated carboxylic acid ester,
   from 5 to 95% by weight of a copolymer of ethylene and of at least one monomer chosen from unsaturated carboxylic acids, unsaturated carboxylic acid anhydrides and unsaturated epoxides,
   optionally another copolymer of ethylene, or polyethylene with a density of between 0.86 and 0.96, for example LLDPE, VLDPE or LDPE.

These adhesives exhibit an adhesion to numerous supports, such as metals or polymers, for example polyesters, polyamides, polyolefins or polymers which exhibit barrier properties towards water, gases or hydrocarbons.

Mention may be made, in coextrusion, among the supports, of polymers such as polyethylene terephthalate (PET), polypropylene (PP), polyvinyl chloride (PVC), polyvinylidene chloride (PVDC), polyvinyl fluoride (PVF), polyvinylidene fluoride (PVDF), polyamide (PA), polystyrene (PS), and the like. These polymers can thus be used in multilayer structures, in particular between a layer of polyethylene terephthalate (PET) and a layer of polyethylene or between a layer of polyester resulting from renewable materials, such as, for example, poly(lactic acid), and a polymer having barrier properties, such as, for example, the saponified ethylene/vinyl acetate (EVOH) copolymer or PA, which have barrier properties towards oxygen.

The present application is also targeted at the uses of the copolymers according to the invention as adhesive or adhesive composition in a multilayer structure.

Thus, the invention relates to a multilayer structure obtained by use of the adhesive composition according to the invention in an extrusion-coating process for application to a support, said support being chosen from aluminum, paper or board, cellophane, films based on polyethylene, polypropylene, polyamide, polyester, polyvinyl chloride (PVC), polyvinylidene chloride (PVDC) or polyacrylonitrile (PAN) resins, these films being or not being orientated, being or not being metalized and being or not being treated by a physical or chemical route, and films coated with a thin inorganic barrier layer, such as polyester (PET SiOₓ or AlOₓ).

The invention also relates to a multilayer structure obtained by use of the adhesive composition of the invention in an extrusion-lamination process for adhesively bonding several supports together, which supports are different in nature; the supports are generally chosen from aluminum, paper or board, cellophane, films based on polyethylene, polypropylene, polyamide, polyester, polyvinyl chloride (PVC), polyvinylidene chloride (PVDC) or polyacrylonitrile (PAN) resins, these films being or not being orientated, being or not being metalized and being or not being treated by a physical or chemical route, and films coated with a thin inorganic barrier layer, such as polyester (PET SiOₓ or AlOₓ).

The present application is also targeted at the use of the compositions according to the invention as sealing layer, in particular over a material chosen from aluminum, polystyrenes (PS), polypropylenes (PP), polyamines (PA), and the like.

The copolymers according to the invention can also be used:
as compatibilizing agent for compounds (that is to say, an adjuvant which makes it possible to improve the compatibility with said compounds), in particular natural fibers, polyolefin/polyamine (PO/PA) alloys, polyolefin/polyester or biopolyester alloys, polyolefin/starch alloys, and the like,
as impact modifier in polymers (that is to say, as adjuvant in a polymer which makes it possible to improve the impact strength of said polymer), such as polyethylene terephthalate (PET) polymers, polyamides (PA), polypropylenes (PP), polybutylene terephthalates (PBT) or biopolyesters (polylactic acid (PLA), polyhydroxyalkanoates (PHA), and the like).

In particular, the invention relates to an impact modifier comprising polypropylene, an ethylene/alkyl acrylate, preferably 2-ethylhexyl acrylate or n-octyl acrylate, copolymer and optionally a polymer chosen from high density polyethylene, LDPE, LLDPE, VLDPE, polyethylene obtained by metallocene catalysis, EPR and EPDM elastomers, polyethylene and EPR or EPDM blends, ethylene/alkyl (meth)acrylate copolymers and ethylene/vinyl acetate copolymers. This impact modifier is described in detail in the application FR 2 828 493.

In particular, the invention relates to an impact modifier comprising:
(a) a core-shell copolymer (A),
(b) a copolymer of ethylene chosen from copolymers of ethylene and of an unsaturated carboxylic acid anhydride, copolymers of ethylene and of an unsaturated epoxide and their blends,
(c) a copolymer chosen from copolymers of ethylene and of an alkyl (meth)acrylate, copolymers of ethylene and of optionally neutralized (meth)acrylic acid and their blends. This impact modifier is described in detail in the patent application EP 1 252 234.

It is also possible to form films from the copolymers, such as encapsulating films for solar panels. It is also possible to form flexible coverings, in particular for the construction industry, for the floor or the walls, or in the automobile industry, agricultural films, that is to say films which can be used in the agricultural field, thermo-adhesive films, protective films or packaging films, in particular food packaging films. It is also possible to form, from the copolymers, gloves for medical hygiene.

These copolymers can also be added to another polymer, such as, for example, PET, in order to facilitate the recycling thereof.

These copolymers can also be used to manufacture a soundproofing body, that is to say a crosslinkable expandable body having a soundproofing function. Flexible components can also be formed from the copolymers of the invention by injection or thermoforming; it is also possible to manufacture pipes or containers, such as bottles or tanks, by tube extrusion or by blow molding.

The copolymers according to the invention can also be present in compositions for manufacturing woven or nonwoven textiles.

Another possible application for the copolymers according to the invention is that of manufacturing masterbatches.

It is also possible to use the copolymers according to the invention to manufacture electric cables. In particular, they can be used to manufacture an electric cable sheath. It is also possible to manufacture compositions by dispersing a conducting compound (for example carbon black) in order to form half-conducting half-insulating compositions (commonly known as semi-conducting compositions); these compositions are of particular use in the manufacture of medium- or high-voltage cables.

These copolymers can also be used in the modification of asphalt.

The copolymer according to the invention can also participate in the composition of a hot-melt adhesive.

In particular, a hot-melt adhesive composition can be formulated by mixing “tackifying” resins, waxes and antioxidants with the copolymers according to the invention. It is also possible to add other additives thereto, such as plasticizers, viscosity reducers, pigments or fillers.

The “tackifying” resins can be solid or liquid and can be used alone or as a mixture; they make it possible mainly to contribute adhesiveness to the composition. Mention may be made, among them, of:
resins based on natural or modified, for example polymerized, rosin resin, in particular pentaerythritol or glycerol esters, terpene or polyterpene resins which are modified,
synthetic resins of α-methylstyrene, styrene/terpene or terpene/phenol type,
resins of hydrocarbon origins, such as aliphatic or aromatic resins which are nonhydrogenated or completely or partially hydrogenated,
waxes, which make it possible to adjust the fluidity and the setting time of the adhesive, can be chosen from the following families: paraffin waxes, microcrystalline waxes, polyethylene waxes, oxidized or nonoxidized Fischer-Tropsch waxes, or functionalized waxes of hydroxystearamide or fatty amide type.

### EXAMPLES

A copolymer of ethylene and of butyl acrylate according to the present invention was prepared from ethylene obtained by employing stages a) and b) according to the process of the present application and by then carrying out a copolymerization (stage c)) using the device described above and presented in the single FIGURE appended as an annex.

The tubular reactor used measures 600 m in length and 42 mm in diameter.

The ethylene is injected at a flow rate of 12 tones/hour (pipe 1) and butyl acrylate is injected at a flow rate of 800 kg/hour (pipe 3); the mixture is compressed in the hypercompressor (Hc) to 2400 bar.

The mixture is preheated to 120° C. in the zone Z1 and then a Lup 11/26 mixture (that is to say, Luperox 11, tert-butyl peroxypivalate/Luperox 26, tert-butyl peroxy-2-ethylhexanoate) is injected via the pipe 12.

In the zone Z2, the temperature rises up to 210° C. and then falls again to 160° C. at the outlet of zone Z2.

A Lup 11/26 mixture is then reinjected in each zone Z3, Z4 and Z5, at the inlet of the zone; the temperature rises up to 210° C. and then falls again to 160° C. at the outlet of the zone.

1.9 tones/hour of ethylene/butyl acrylate copolymer, with a butyl acrylate content of 30% by weight and a melt flow index of 2, are obtained.

What is claimed is:

1. A copolymer of ethylene and of at least one unsaturated carboxylic acid or unsaturated carboxylic acid derivative, in which the ethylene is at least partially obtained from renewable starting materials.

2. The copolymer as claimed in claim 1, in which at least a portion of the carbon atoms of the unsaturated carboxylic acid or of the unsaturated carboxylic acid derivative is of renewable origin.

3. The copolymer as claimed in claim 1, in which the unsaturated carboxylic acid or unsaturated carboxylic acid derivative is chosen from:
(meth)acrylic acids,
alkyl (meth)acrylates, the number of carbon atoms of the alkyl part of which ranges from 1 to 24; preferably, methyl acrylate, ethyl acrylate, n-butyl acrylate, isobutyl acrylate or 2-ethylhexyl acrylate,
unsaturated carboxylic acid anhydrides chosen from maleic anhydride, itaconic anhydride, citraconic anhydride or tetrahydrophthalic anhydride,
unsaturated epoxides chosen from:
aliphatic glycidyl esters and ethers, such as allyl glycidyl ether, vinyl glycidyl ether, glycidyl maleate, glycidyl itaconate, glycidyl acrylate and glycidyl methacrylate (GMA), and
alicyclic glycidyl esters or ethers, such as 2-cyclohexen-1-yl glycidyl ether, diglycidyl cyclohexene-4,5-dicarboxylate, glycidyl cyclohexene-4-carboxylate, glycidyl 5-norbornene-2-methyl-2-carboxylate and diglycidyl endo-cis-bicyclo[2.2.1]hept-5-ene-2,3-dicarboxylate.

4. The copolymer as claimed in claim 1, characterized in that it is chosen from:
random copolymers of ethylene and of methacrylic acid, random copolymers of ethylene and of acrylic acid, random copolymers of ethylene and of methyl acrylate, random copolymers of ethylene and of butyl acrylate, random copolymers of ethylene and of maleic anhydride or random copolymers of ethylene and of glycidyl methacrylate,
random terpolymers of ethylene, of butyl acrylate and of maleic anhydride, random terpolymers of ethylene, of methyl acrylate and of maleic anhydride and random terpolymers of ethylene, of methyl acrylate and of glycidyl methacrylate.

5. The copolymer as claimed in claim 1, characterized in that it comprises at least 0.24×10⁻¹⁰% by weight of ¹⁴C, this amount of ¹⁴C being determined by one of the methods described in the standard ASTM D6866-06.

6. A process for the manufacture of a copolymer of ethylene and of at least one unsaturated carboxylic acid or unsaturated carboxylic acid derivative as claimed in claim 1, comprising the following stages:
a) fermenting renewable starting materials and optionally purification, in order to produce at least one alcohol chosen from ethanol and mixtures of alcohols comprising ethanol;
b) dehydrating the alcohol obtained in order to produce at least one alkene chosen from ethylene and mixtures of alkenes comprising ethylene and optionally purification of the alkene in order to obtain ethylene,
c) copolymerizing the ethylene with at least one comonomer chosen from unsaturated carboxylic acid or unsaturated carboxylic acid derivative,
d) isolating the copolymer obtained.

7. The process for the manufacture of a copolymer as claimed in claim 6, wherein the renewable starting materials are plant materials selected from the group consisting of sugar cane and sugar beet, maple, date palm, sugar palm, sorghum, American agave, corn, wheat, barley, sorghum, rice, potato, cassaya, sweet potato, algae, materials comprising cellulose, materials comprising hemicelluloses, wood, straw, and paper.

8. The process for the manufacture of a copolymer as claimed in claim 6, wherein the copolymerization of stage c) is a high-pressure radical copolymerization carried out by introducing the ethylene, the comonomer or comonomers and an initiator of polymerization at elevated pressure into an autoclave reactor, at a temperature of between 150 and 290° C., the amount of the comonomers introduced ranging up to 20% by weight, with respect to the total amount of ethylene and comonomers introduced into the reactor.

9. The process for the manufacture of a copolymer as claimed in claim 6, wherein the copolymerization of stage c) is a high-pressure radical copolymerization carried out by introducing the ethylene, the comonomer or comonomers and an initiator of polymerization at elevated pressure into a tubular reactor, at a temperature of between 80 and 325° C., the amount of the comonomers introduced ranging up to 20% by weight, with respect to the total amount of ethylene and comonomers introduced into the reactor.

10. The process for the manufacture of a copolymer as claimed in claim 9, characterized in that the mixture of the ethylene and the comonomers is injected at least at another location in the reactor, this injection being itself followed by a further injection of initiator or of mixture of initiators.

11. A composition comprising at least one copolymer as claimed in claim 1, characterized in that it comprises:
a terpolymer of ethylene, of an unsaturated carboxylic acid ester and of a comonomer chosen from unsaturated carboxylic acids, unsaturated carboxylic acid anhydrides and unsaturated epoxides, or
a mixture of a copolymer of ethylene and of an unsaturated carboxylic acid ester and of a copolymer of ethylene and of at least one comonomer chosen from unsaturated carboxylic acids, unsaturated carboxylic acid anhydrides and unsaturated epoxides.

12. The composition as claimed in claim 11, comprising at least one additive chosen from antioxidants; UV protection agents; processing aids; defogging agents; antiblocking agents; fillers; coupling agents; crosslinking agents; antistatic agents; nucleating agents; pigments; dyes; plasticizers; viscosity reducers; or flame-retardant additives.

13. The use of at least one copolymer as claimed in claim 1 as adhesive or adhesive composition in coextrusion, in extrusion-coating or in extrusion-lamination.

14. The use of at least one copolymer as claimed in claim 1 in order to form films, such as encapsulating films for solar panels, packaging films, in particular for food packaging films, flexible coverings, in particular for the building industry, for the floor or the walls, or in the motor vehicle industry, or thermo-adhesive films; in the composition of a soundproofing body, of flexible components, such as pipes or bottles, or of electric cable sheaths; for the modification of asphalt; or in order to form hot-melt adhesives.

15. The use of at least one copolymer as claimed in claim 1 as compatibilizing agent for compounds or as an impact modifier in polymers.

16. The process for the manufacture of a copolymer as claimed in claim 7, characterized in that the copolymerization of stage c) is a high-pressure radical copolymerization carried out by introducing the ethylene, the comonomer or comonomers and an initiator of polymerization at elevated pressure into an autoclave reactor, at a temperature of between 150 and 290° C., the amount of the comonomers introduced ranging up to 20% by weight, with respect to the total amount of ethylene and comonomers introduced into the reactor.

17. The process for the manufacture of a copolymer as claimed in claim 7, characterized in that the copolymerization of stage c) is a high-pressure radical copolymerization carried out by introducing the ethylene, the comonomer or comonomers and an initiator of polymerization at elevated pressure into a tubular reactor, at a temperature of between 80 and 325° C., the amount of the comonomers introduced ranging up to 20% by weight, with respect to the total amount of ethylene and comonomers introduced into the reactor.

18. The process for the manufacture of a copolymer as claimed in claim 17, characterized in that the mixture of the ethylene and the comonomers is injected at least at another location in the reactor, this injection being itself followed by a further injection of initiator or of mixture of initiators.
